(19) United States
(12) Patent Application Publication
(10) Pub. No.: US 2023/0044847 A1
(43) Pub. Date: Feb. 9, 2023

(54) 5G Non-Seamless Wireless Local Area Network Offload

(71) Applicant: QUALCOMM Incorporated, San Diego, CA (US)

(72) Inventors: Anand PALANIGOUNDER, San Diego, CA (US); Adrian Edward ESCOTT, Reading (GB); Soo Bum LEE, San Diego, CA (US); Hongil KIM, San Diego, CA (US)

(21) Appl. No.: 17/817,644

(22) Filed: Aug. 4, 2022

Related U.S. Application Data
(60) Provisional application No. 63/230,784, filed on Aug. 8, 2021.

(51) Int. Cl. H04W 12/06; H04W 12/033; H04W 12/0431

(52) U.S. Cl. CPC H04W 12/06; H04W 12/033; H04W 12/0431; H04W 84/12

(57) ABSTRACT

Embodiments may include a user equipment (UE) configured to obtain a Mobile Subscriber Identification Number (MSIN) from an International Mobile Subscriber Identity (IMSI) of the UE, encrypt the MSIN to generate a Subscription Concealed Identifier (SUCI) in a Network Access Identifier (NAI) format, and send the SUCI to the non-3GPP access network for authentication of the UE, and a network element of a home 3GPP network configured to receive, by a 5G Non-seamless WLAN Offload (NSWO) Function, an authentication request including the SUCI from the non-3GPP access network, determine, by the 5G NSWO Function, based on the SUCI, that the UE should be authenticated by an authentication function of the home 3GPP network, and provide the authentication request including the SUCI to the authentication function of the home 3GPP network for processing based on the determination that the UE should be authenticated by the authentication function.

### RELATED APPLICATIONS

This application claims the benefit of priority to U.S. Provisional Application No. 63/230,784 entitled “5G Non-Seamless Wireless Local Area Network Offload” filed Aug. 8, 2021, the entire contents of which are hereby incorporated by reference for all purposes.

### BACKGROUND

Non-seamless Wireless Local Area Network (WLAN) Offload (NSWO) enables authentication of a user equipment (UE) by a home network of the UE for access to another access network, such as a Wi-Fi network. In NSWO procedures for Fourth Generation (4G) communication systems, a UE sends a UE identifier in an unencrypted form (i.e., in the clear) over a wireless communication link to the access network. If subscriber identity privacy is not provided during an authentication procedure, then a UE may be vulnerable to capture and misuse of a UE identifier (e.g., by an “IMSI catcher”), which may enable surreptitious tracking of UE activity or misuse of the UE identifier for attacks on the network or other malicious activity.

### SUMMARY

Various aspects include systems and methods for performing authentication of a user equipment (UE) using Non-seamless Wireless Local Area Network (WLAN) Offload (NSWO) facilitated by network elements and functions of a 5G NR (Fifth Generation New Radio) communication system. Various aspects may include a system for performing authentication of a user equipment (UE), including a non-3GPP access network, a UE, including a processor configured with processor-executable instructions to obtain a Mobile Subscriber Identification Number (MSIN) from an International Mobile Subscriber Identity (IMSI) of the UE, encrypt the MSIN to generate a Subscription Concealed Identifier (SUCI) in a Network Access Identifier (NAI) format, and send the SUCI to the non-3GPP access network for authentication of the UE, and a network element of a home 3GPP network, including a processor configured with processor-executable instructions to receive, by a 5G Non-seamless WLAN Offload (NSWO) Function, an authentication request including the SUCI from the non-3GPP access network, determine, by the 5G NSWO Function, based on the SUCI, that the UE should be authenticated by an authentication function of the home 3GPP network, and provide the authentication request including the SUCI to the authentication function of the home 3GPP network for processing based on the determination that the UE should be authenticated by the authentication function.

In some aspects, the processor of the UE may be further configured to receive an identity request from the non-3GPP access network, and determine based on an indicator stored in the UE whether the UE is configured to perform 5G NSWO in response to the identity request. In some aspects, the processor of the network element of the home 3GPP network may be further configured to determine, by the 5G NSWO Function, whether the SUCI is in the NAI format. In some aspects, the authentication function may process the authentication request including the SUCI in response to determining that the SUCI is in the NAI format. In some aspects, the authentication function may include an Authentication Server Function (AUSF).

In some aspects, the non-3GPP access network may be further configured to establish a communication link with the UE, and send to the UE an identity request in response to establishing the communication link with the UE. In some aspects, the processor of the network element of the home 3GPP network may be further configured to receive, by the 5G NSWO Function from the authentication function, an authentication response based on the processing of the authentication request including the SUCI, and send, by the 5G NSWO Function, an authentication challenge to the non-3GPP access network in response to receiving the authentication response from the authentication function.

In some aspects, the processor of the UE may be further configured to receive the authentication challenge from the non-3GPP access network, generate an authentication response in response to the authentication challenge, and send to the non-3GPP access network the authentication response. In some aspects, the processor of the UE may be further configured to generate a key using an arbitrary value for a serving network name of the non-3GPP access network.

In some aspects, the processor of the network element of the home 3GPP network may be further configured to receive, by the 5G NSWO Function from the UE via the non-3GPP access network, the authentication response in response to the authentication challenge, provide the authentication response to the authentication function of the home 3GPP network, and receive, by the 5G NSWO Function from the authentication function of the home 3gpp network, a Master Session Key (MSK) responsive to the authentication response. In some aspects, the processor of the network element of the home 3GPP network may be further configured to send the MSK to the non-3GPP access network to authenticate the UE for access to the non-3GPP access network. In some aspects, the MSK may be derived using an arbitrary value for a serving network name of the non-3GPP access network.

Various aspects include a method for performing authentication of a UE for 5G network authentication to support 5G Non-seamless WLAN Offload (5G NSWO) on a non-3GPP access network. Various aspects may include obtaining, by a processor of a UE, a Mobile Subscriber Identification Number (MSIN) from an International Mobile Subscriber Identity (IMSI) of the UE, encrypting, by the processor of the UE, the MSIN to generate a Subscription Concealed Identifier (SUCI) in a Network Access Identifier (NAI) format, sending, by the processor of the UE, the SUCI to the non-3GPP access network for authentication of the UE, receiving, from the non-3GPP access network by a 5G NSWO Function of a network element of a home 3GPP network, an authentication request including the SUCI, determining, by the 5G NSWO Function, based on the SUCI, that the UE should be authenticated by an authentication function of the home 3GPP network, providing the authentication request including the SUCI to the authentication function of the home 3GPP network for processing based on the determination that the UE should be authenticated by the authentication function, and completing authentication of the UE according to the Extensible Authentication Protocol (EAP) protocol.

In some aspects, determining, by the 5G NSWO Function, based on the SUCI, that the UE should be authenticated by an authentication function of the home 3GPP network may include determining, by the 5G NSWO Function, that the SUCI is in the NAI format. Some aspects may include processing, by the authentication function, the authentication request including the SUCI in response to determining that the SUCI is in the NAI format. In some aspects, the authentication function may include an Authentication Server Function (AUSF).

Various aspects include a method performed by a processor of a user equipment (UE) for 5G network authentication to support 5G Non-seamless WLAN Offload (NSWO). Various aspects may include obtaining a Mobile Subscriber Identification Number (MSIN) from an International Mobile Subscriber Identity (IMSI) of the UE, encrypting the MSIN to generate a Subscription Concealed Identifier (SUCI) in a Network Access Identifier (NAI) format, and sending the SUCI to a network element of a non-3GPP access network for authentication of the UE by a home 3GPP network for access to the non-3GPP access network.

Some aspects may include checking a Universal Subscriber Identity Module (USIM) or a mobile equipment (ME) setting for an indication that the UE should use 5G NSWO, wherein encrypting the MSIN to generate the SUCI in the NAI format and sending the SUCI to the network element of the non-3GPP access network for authentication of the UE by the home 3GPP network for access to the non-3GPP access network is performed in response to the USIM or the ME setting indicating that the UE should use 5G NSWO. In some aspects, obtaining the MSIN from the IMSI of the UE may include obtaining by an ME function of the UE an encrypted MSIN from a USIM of the UE, and generating by the ME the SUCI in the NAI format using the encrypted MSIN. Some aspects may include receiving an Extensible Authentication Protocol and Key Agreement prime (EAP-AKA′)-Challenge from the network element of the non-3GPP access network, calculating an EAP-Response via an Authentication and Key Agreement (AKA) algorithm, deriving one or more keys using an arbitrary value for the serving network name of the non-3GPP access network, sending the EAP-Response to the network element of the non-3GPP access network, receiving an EAP Success from the network element of the non-3GPP access network, and initiating communications over the non-3GPP access network via the network element of the non-3GPP access network in response to receiving the EAP Success.

Various aspects include systems and methods for performing authentication to support 5G Non-seamless NSWO on a non-3GPP access network. Various aspects may include checking, by a processor of a UE, a USIM or an ME setting for an indication that the UE should use 5G NSWO, in response to the USIM or the ME setting indicating that the UE should use 5G NSWO generating, by the processor of the UE, a SUCI in NAI format, and sending, by the processor of the UE, the SUCI in NAI format to a non-3GPP access network for authentication of the UE.

In some aspects, sending, by the processor of the UE, the SUCI in NAI format to the non-3GPP access network for authentication of the UE may include receiving, by the UE, an identity request from the non-3GPP access network, in which sending, by the processor of the UE, the SUCI in NAI format to the non-3GPP access network for authentication of the UE is performed in response to the identity request from the non-3GPP access network.

In some aspects, generating, by the processor of the UE, the SUCI in NAI format may include encrypting, by the processor of the UE, an MSIN obtained from an IMSI of the UE and including the encrypted MSIN in the SUCI. In some aspects, generating, by the processor of the UE, the SUCI in NAI format may include obtaining by an ME function of the UE an encrypted MSIN from a USIM of the UE, and to generate the SUCI in NAI format, the ME function uses the encrypted MSIN.

In some aspects, to generate the SUCI in NAI format, the processor of the UE may encrypt a username portion of an NAI and incorporate the encrypted username portion in the SUCI. In some aspects, the SUCI in NAI format may include an indication of whether the SUCI is derived from an IMSI of the UE or an NAI. In some aspects, generating, by the processor of the UE, the SUCI in NAI format may include converting digits of an IMSI of the UE into a domain name.

Some aspects may include receiving an Extensible Authentication Protocol and Key Agreement prime (EAP-AKA′)-Challenge from a network element of the non-3GPP access network, deriving one or more keys using an arbitrary value for a serving network name of the non-3GPP access network, sending an EAP-Response to the network element of the non-3GPP access network, and initiating communications over the non-3GPP access network via the network element of the non-3GPP access network using the one or more derived keys. In some aspects, initiating communications over the non-3GPP access network via the network element of the non-3GPP access network may include receiving an EAP Success from the network element of the non-3GPP access network, and initiating communications over the non-3GPP access network via the network element of the non-3GPP access network in response to receiving the EAP Success.

Further aspects may include a UE or a network element having a processor configured to perform one or more operations of any of the methods summarized above. Further aspects may include a non-transitory processor-readable storage medium having stored thereon processor-executable instructions configured to cause a processor of a wireless device or a UE or a network element to perform operations of any of the methods summarized above. Further aspects include a UE or a network element having means for performing functions of any of the methods summarized above. Further aspects include a system on chip for use in a UE or a network element that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a system block diagram illustrating an example communication system suitable for implementing any of the various embodiments.

FIG. 1B is a system block diagram illustrating an example disaggregated base station architecture suitable for implementing various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4 is a message flow diagram illustrating a method for performing authentication of a user equipment in accordance with various embodiments.

FIGS. 5A and 5B are method flow diagrams illustrating a method for performing authentication of a user equipment in accordance with various embodiments.

FIG. 6A is a process flow diagram illustrating a method that may be performed by a processor of a UE for 5G network authentication to support 5G NSWO according to various embodiments.

FIG. 6B is a process flow diagram illustrating a method that may be performed by a processor of a UE for 5G network authentication to support 5G NSWO according to various embodiments.

FIG. 7 is a component block diagram of a network computing device suitable for use with various embodiments.

FIG. 8 is a component block diagram of a wireless device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include systems and methods for performing Non-seamless Wireless Local Area Network (WLAN) Offload (NSWO) authentication for a UE attempting to access a non-3GPP access network (e.g., an Institute of Electrical and Electronics Engineers (IEEE) 802.11 WLAN access network). Various embodiments may improve the efficiency and accuracy of wireless communications between a wireless device and a communication network by providing NSWO communications with the enhanced security features provided by 5G systems.

The term “wireless device” is used herein to refer to any one or all of wireless router devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. An SIP may also include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

Most UEs require authentication to access a communication network. NSWO using 4G protocols enables authentication of a UE attempting to connect to a non-3GPP access network (e.g., a WLAN) via network elements, functions, and credentials provided by a home network of the UE, such as a cellular network employing Third Generation Partnership Project (3GPP) protocols and systems.

One problem with current NSWO using 4G protocols is that the identifier of the UE is transmitted in the clear, and as a result, there is a risk that the UE's identifier may be intercepted and used for fraudulent purposes. Providing network access to unauthenticated UEs may enable misuse of network access via NSWO by fraudulent UEs. For example, fraudulent UEs accessing an enterprise WLAN without authentication may consume WLAN resources and reduce availability of NSWO for legitimate UEs (such as by a Distributed Denial of Service (DDoS) attack, and the like). 5G communication systems and protocols provide for communicating UE identifiers in a concealed (or encrypted) format, thereby providing greater security. The deployment and use of NSWO with 5G NR communication networks would enable the use of such enhanced security capabilities of 5G systems with NSWO.

Various embodiments include systems and methods that enable the deployment and use of NSWO with 5G NR communication networks (sometimes referred to herein as “5G NSWO”). Various embodiments leverage the enhanced security capability of 5G protocols by implementing NSWO authentication procedures supported by elements of a 5G core network using credentials provided by a function of the 5G core network, such as a Unified Data Management (UDM) function, an Authentication Credential Repository and Processing Function (ARPF), a Subscription Identifier De-concealing Function (SIDF), and/or the like. Various embodiments provide a 5G NSWO process with enhanced UE identity security by avoiding sending the UE identifier (e.g., a Subscription Permanent Identifier (SUPI) or International Mobile Subscriber Identity (IMSI)) in an unencrypted form (i.e., in the clear). While UEs may be provisioned to use an authentication protocol such as Extensible Authentication Protocol (e.g., Extensible Authentication Protocol and Key Agreement prime (EAP-AKA′)), UEs and network elements or network functions require adaptation to implement NSWO for 5G communication systems.

In various embodiments, the UE may be configured by the home network operator to use 5G NSWO for offloading traffic to a non-3GPP access network, such as a WLAN. A UE may establish a communication link with an access point of a non-3GPP access network (e.g., a WLAN network employing Wi-Fi or another suitable wireless communication protocol, via a WLAN access point or another suitable device). As part of establishing such communications, the access point of the non-3GPP access network may send to the UE an identity request. At any point before receiving the identity request, or in response to receiving the identity request, the UE may determine whether the UE is configured to perform (use, perform operations of, etc.) 5G NSWO for authentication to access the non-3GPP access network. In some embodiments, the UE may check (determine, obtain) a Universal Subscriber Identity Module (USIM) or a mobile equipment (ME) setting for an indication whether the UE should use 5G NSWO. In response to determining that the UE is configured to use 5G NSWO for authentication, the UE may generate a Subscription Concealed Identifier (SUCI) (i.e., a concealed version of the SUPI) in Network Access Identifier (NAI) format.

A SUPI may be configured as a SUPI Type, such as SUPI Type 0 for an International Mobile Subscriber Identity (IMSI) type, or SUPI Type 1 for NAI type. If the SUPI configured on the UE is an IMSI type identifier, the UE may obtain a Mobile Subscriber Identification Number (MSIN) from the IMSI of the UE. In some embodiments, the UE may encrypt the MSIN to generate the SUCI in the NAI format. In some implementations, a SUPI may include a string of 15 decimal digits, in which the first three digits represent a Mobile Country Code (MCC) and the next two or three digits represent a Mobile Network Code (MNC) identifying the network operator. In some embodiments, using the encrypted MSIN, a mobile equipment (ME) function of the UE may derive the SUCI in NAI format (e.g., username @ realm format) by incorporating the encrypted MSIN in a username part of the NAI and incorporating the MCC values and MNC value of the IMSI in the realm part of the NAI.

If the SUPI configured on the UE is an NAI type identifier, then the UE may encrypt the username portion of the NAI and incorporate the encrypted username in the username portion of the SUCI to form a SUCI in NAI format. In some embodiments, either the ME or the USIM may perform the encryption of the MSIN or the username using procedures defined in 3GPP Technical Specification (TS) 33.501.

The UE may send the derived SUCI in the NAI format to the network element of the non-3GPP access network for authentication of the UE by the home 3GPP network for access to the non-3GPP access network. In some embodiments, the SUCI in NAI format may incorporate the SUPI type to indicate whether the SUCI is derived from an IMSI or an NAI.

One or more network elements of the non-3GPP access network may send an access request (which may be, or may include, a request to authenticate the UE) related to the UE to the home 3GPP network of the UE (e.g., a 5G NR communication network) via standard 3GPP communication networks. In some embodiments, the non-3GPP access network may send an Authentication, Authorization, and Accounting (AAA) Request with a User-Name set to the SUCI in NAI format to the home 3GPP network. A network element of the home 3GPP network may receive the access (authentication) request including the SUCI from the non-3GPP access network. In some embodiments, a 5G NSWO Function implemented in a network element of the home 3GPP network may receive the authentication request. In some embodiments, the 5G NSWO Function may be implemented in a new network element or in an enhanced or upgraded 3GPP AAA server in the existing 4G network. In some embodiments, the 5G NSWO Function may determine based on the SUCI that the UE should be authenticated using 5G NSWO procedures (e.g., instead of 4G NSWO procedures) and may forward the authentication request to an authentication function in the 5G core network, such as an Authentication Server Function (AUSF). For example, the 5G NSWO Function of the home 3GPP network may determine that the NAI is a 5G SUCI. In response to determining that the NAI is a 5G SUCI, the network element of the home 3GPP network may provide the authentication request including the SUCI to the authentication function of the home 3GPP network implemented in a network element of the home 3GPP network. In some embodiments, the 5G NSWO network function may set the serving network name to an arbitrary string value (e.g., “5G:NSWO”) to indicate that the authentication request is for 5G NSWO over a non-3GPP access network such as WLAN access networks.

In some embodiments, the authentication function (e.g., AUSF) of the home 3GPP network of the 5G NSWO Function may send the SUCI in an authentication get request to a repository of UE secure identifiers and credentials (e.g., a UDM/ARPF/SIDF) and receive authentication information that the authentication function (e.g., an AUSF) can use to generate an authentication challenge message, such as according to the EAP-AKA′ protocol. The UDM/ARPF/SIDF may de-conceal the SUCI into the SUPI and use the SUPI to select the EAP-AKA′ as the authentication protocol. The authentication function (e.g., AUSF) may send the authentication challenge message to the non-3GPP access network, such as via the 5G NSWO Function, and the non-3GPP access network may send the authentication challenge to the UE. Upon receiving the authentication challenge from the non-3GPP access network, the UE may generate an authentication response to the authentication challenge, such as according to EAP-AKA′ protocol, and send the authentication response to the non-3GPP access network. The 5G NSWO Function may receive the authentication response from the UE via the non-3GPP access network. The 5G NSWO Function may provide the authentication response to the authentication function (e.g., AUSF) of the home 3GPP home network. The authentication function (e.g., AUSF) of the home 3GPP network may verify the UE authentication response. The authentication function may generate a Master Session Key (MSK) in response to verifying the UE authenticating response, and may send the MSK to the 5G NSWO Function. The AUSF may include the SUPI (e.g., IMSI or NAI based on the SUPI type) as an Identity for the MK (master key) key derivation. MSK (master session key) derivation may also include an arbitrary value for the serving network name. The 5G NSWO Function may send the MSK to the non-3GPP access network to authenticate the UE for access to the non-3GPP access network. In response, the may send a message (e.g., EAP success message) to the UE indicating that the authentication was successful or that the UE has been authenticated and 5G NSWO communications can commence.

In some embodiments, the UE may derive (e.g., determine or calculate) a key using an arbitrary value for the serving network name. In some embodiments, the actual serving network name (i.e., serving network identifier or the non-3GPP access network identifier) may be unavailable to the UE and/or to the home 3GPP network (e.g., to the authentication function of the home 3GPP network). In some embodiments, the authentication function (e.g., AUSF) may use an arbitrary value for a serving network name of the non-3GPP access network to derive (determine, calculate) the MSK.

Various embodiments improve the operation of communication networks by enabling NSWO operations involving elements of a 5G communication system to authenticate a UE for access to a non-3GPP access network. Various embodiments improve the operation of UEs by providing an efficient process for authenticating the UE to a non-3GPP access network using credentials and authentication processes provided by the home 3GPP network.

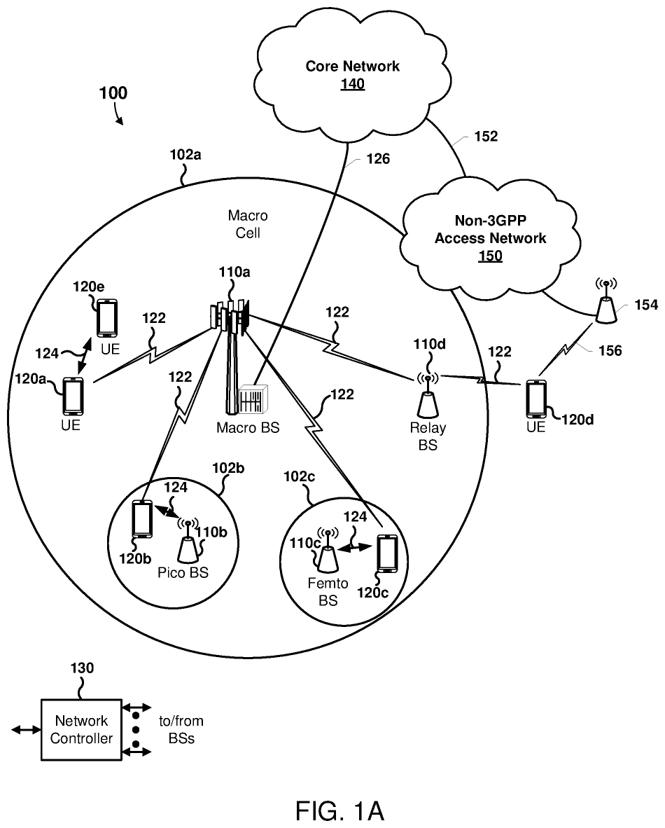

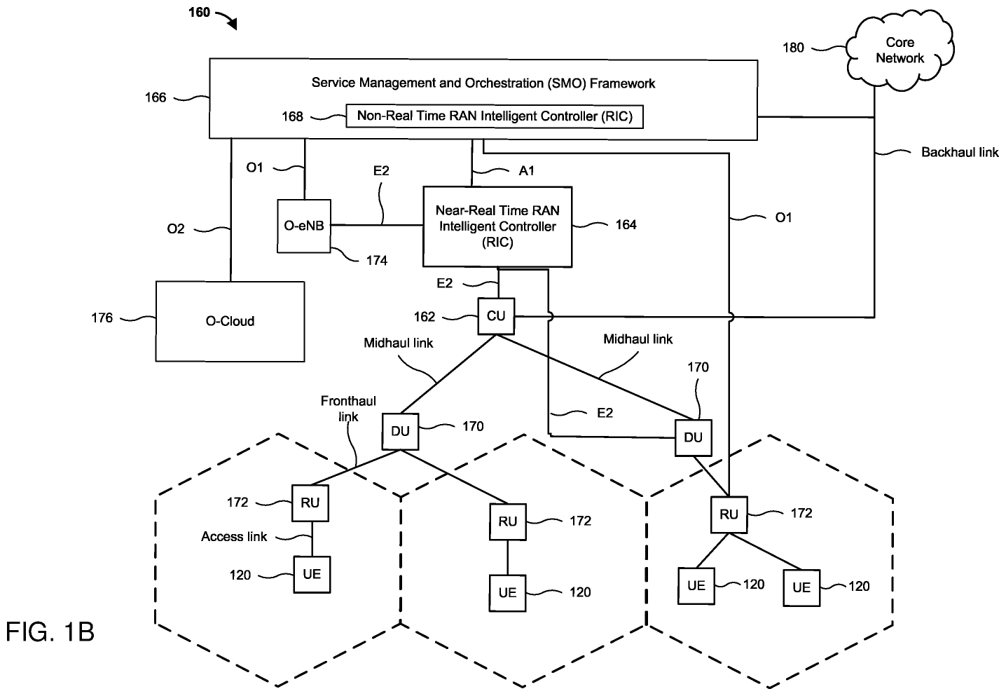

FIG. 1 is a system block diagram illustrating an example communication system 100 suitable for implementing any of the various embodiments. The communications system 100 may be a 5G New Radio (NR) network, or any other suitable network such as a Long Term Evolution (LTE) network. While FIG. 1 illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of mobile devices (illustrated as wireless device 120a-120e in FIG. 1). The communications system 100 may also include a number of base stations (illustrated as the BS 110a, the BS 110b, the BS 110c, and the BS 110d) and other network entities. A base station is an entity that communicates with wireless devices (mobile devices), and also may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type of core network, such as an LTE core network (e.g., an EPC network), 5G core network, etc.

The communications system 100 may include a non-3GPP access network 150. Elements of the core network 140 and the non-3GPP access network 150 may communication over a communication link 152. The non-3GPP access network 150 may include one or more access points 154 that enable wireless communications with a wireless device (e.g., 120d) via a communication link 156. In some embodiments, the core network 140 may provide functions as a home 3GPP network, among other things, for providing authentication functions for a wireless device to access the non-3GPP access network 150, as further described below.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by mobile devices with service subscription. A pico cell may cover a relatively small geographic area and may allow unrestricted access by mobile devices with service subscription. A femto cell may cover a relatively small geographic area (for example, a home) and may allow restricted access by mobile devices having association with the femto cell (for example, mobile devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network.

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (e.g., relay BS 110d). A relay station is an entity that can receive a transmission of data from an upstream station (for example, a base station or a mobile device) and send a transmission of the data to a downstream station (for example, a wireless device or a base station). A relay station also may be a mobile device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, user equipment (UE), etc.

A macro base station 110a may communicate with the communication network 140 over a wired or wireless communication link 126. The wireless devices 120a, 120b, 120c may communicate with a base station 110a-110d over a wireless communication link 122.

The wireless communication links 122, 124, and 156 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee®, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some embodiments may use terminology and examples associated with LTE technologies, various embodiments may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplexing (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding may also be supported. MIMO configurations in the DL may support up to eight transmit antennas with multi-layer DL transmissions up to eight streams and up to two streams per wireless device. Multi-layer transmissions with up to 2 streams per wireless device may be supported. Aggregation of multiple cells may be supported with up to eight serving cells. Alternatively, NR may support a different air interface, other than an OFDM-based air interface.

Some mobile devices may be considered machine-type communication (MTC) or evolved or enhanced machine-type communication (eMTC) mobile devices. MTC and eMTC mobile devices include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as the Internet or a cellular network) via a wired or wireless communication link. Some mobile devices may be considered Internet-of-Things (IoT) devices or may be implemented as NB-IoT (narrowband internet of things) devices. The wireless device 120a-120e may be included inside a housing that houses components of the wireless device 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some embodiments, two or more mobile devices 120a-120e (for example, illustrated as the wireless device 120a and the wireless device 120e) may communicate directly using one or more sidelink channels 124 (for example, without using a base station 110a-110d as an intermediary to communicate with one another). For example, the wireless devices 120a-120e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120e may perform scheduling operations, resource selection operations, as well as other operations described elsewhere herein as being performed by the base station 110a.

FIG. 1B is a system block diagram illustrating an example disaggregated base station 160 architecture that may be part of a V2X and/or 5G network (e.g., the communication system 100) according to any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, user equipment (UE), such as a V2X processing system 104, may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via 01) or via creation of RAN management policies (such as A1 policies).

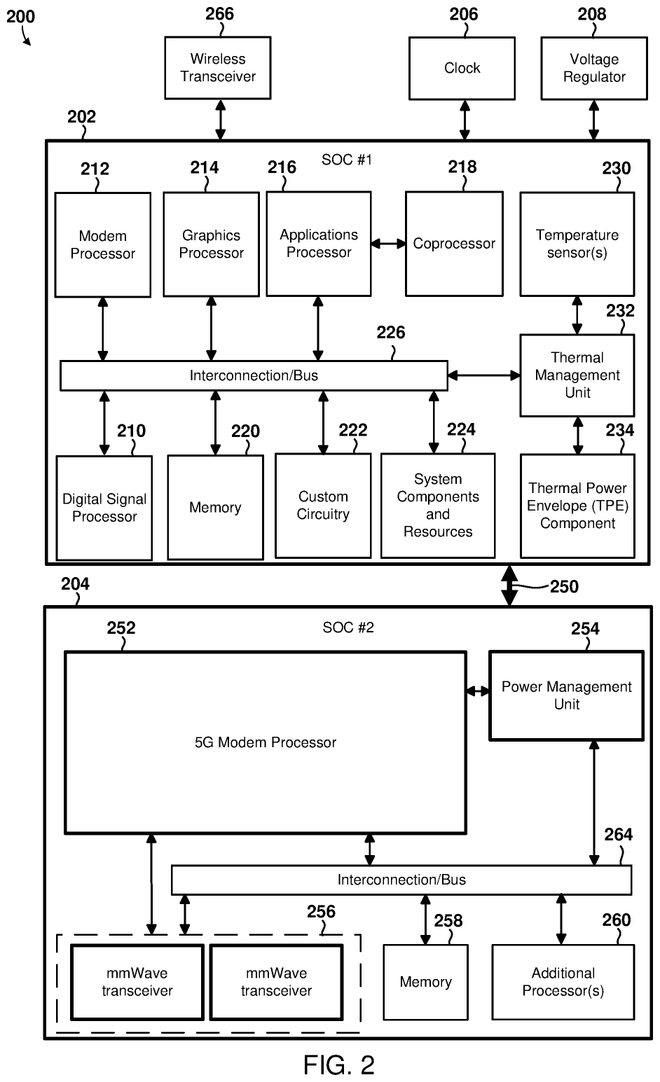

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a wireless device (e.g., 120a-120e) or a base station (e.g., 110a-110d). In some embodiments, the first SOC 202 may operate as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, the plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

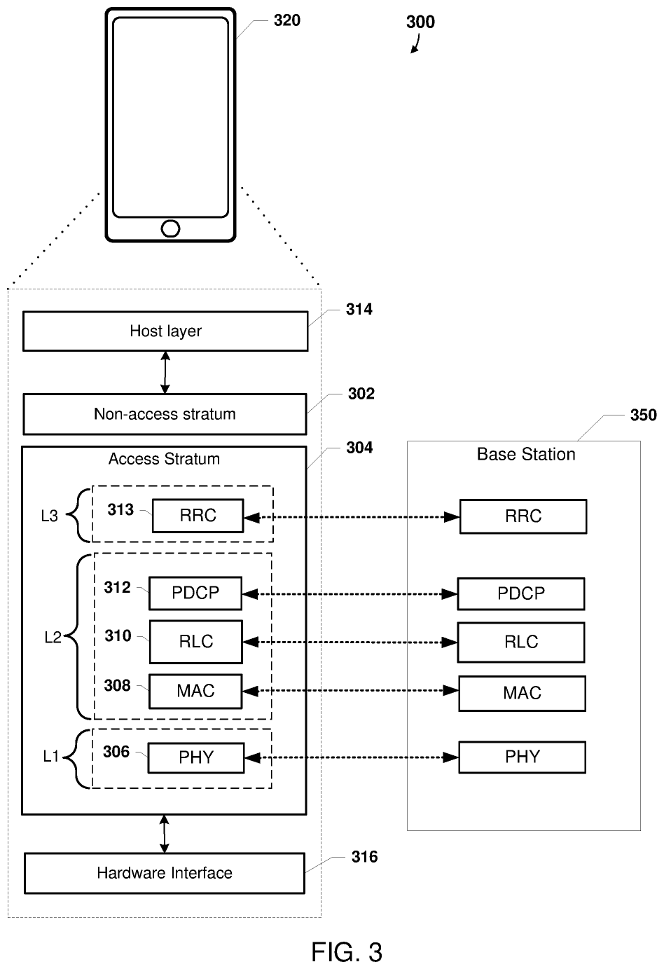

FIG. 3 is a component block diagram illustrating a software architecture 300 including a radio protocol stack for the user and control planes in wireless communications suitable for implementing any of the various embodiments. With reference to FIGS. 1A-3, the wireless device 320 may implement the software architecture 300 to facilitate communication between a wireless device 320 (e.g., the wireless device 120a-120e, 200) and the base station 350 (e.g., the base stations 110a-110d) of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (e.g., SIM(s) 204) and its core network 140. The AS 304 may include functions and protocols that support communication between a SIM(s) (e.g., SIM(s) 204) and entities of supported access networks (e.g., a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In the various embodiments, Layer 2 may include a media access control (MAC) sublayer 308, a radio link control (RLC) sublayer 310, and a packet data convergence protocol (PDCP) 312 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In various embodiments, the RRC sublayer 313 may provide functions including broadcasting system information, paging, and establishing and releasing an RRC signaling connection between the wireless device 320 and the base station 350.

In various embodiments, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some embodiments, application-specific functions provided by the at least one host layer 314 may provide an interface between the software architecture and the general purpose processor 206.

In other embodiments, the software architecture 300 may include one or more higher logical layer (e.g., transport, session, presentation, application, etc.) that provide host layer functions. For example, in some embodiments, the software architecture 300 may include a network layer (e.g., Internet Protocol (IP) layer) in which a logical connection terminates at a packet data network (PDN) gateway (PGW). In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more radio frequency (RF) transceivers).

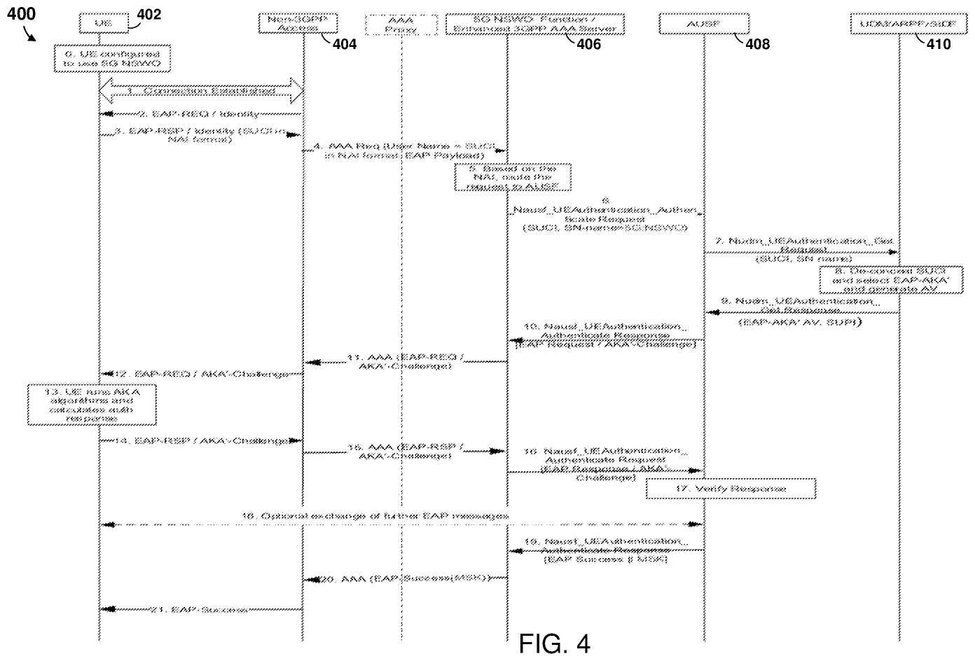

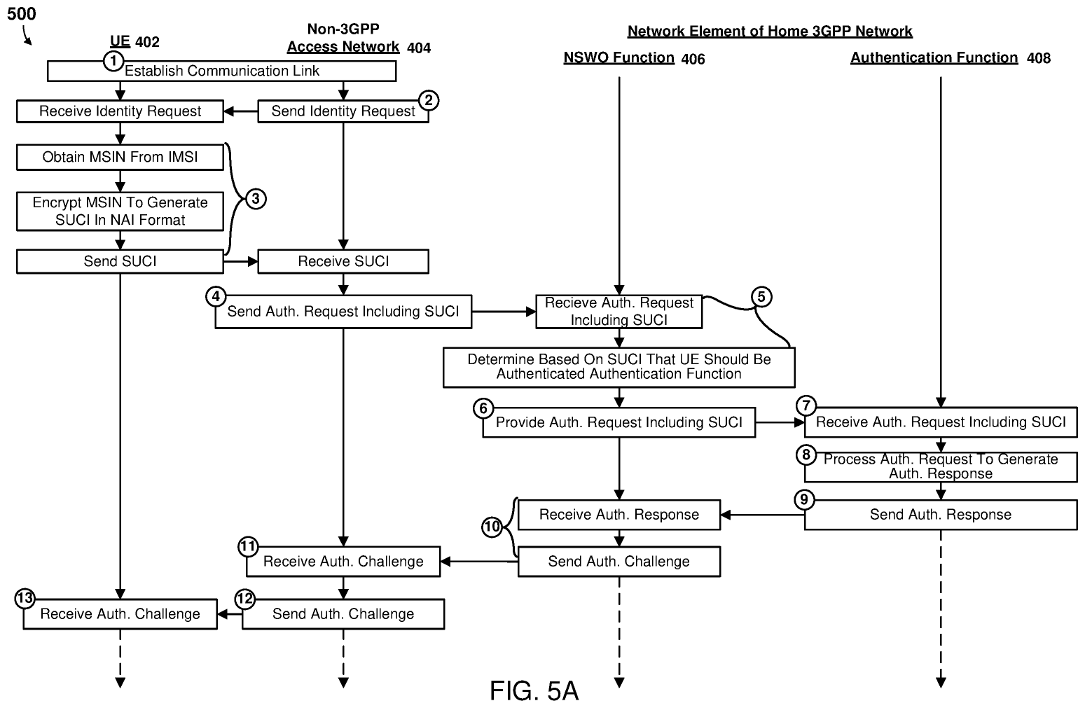

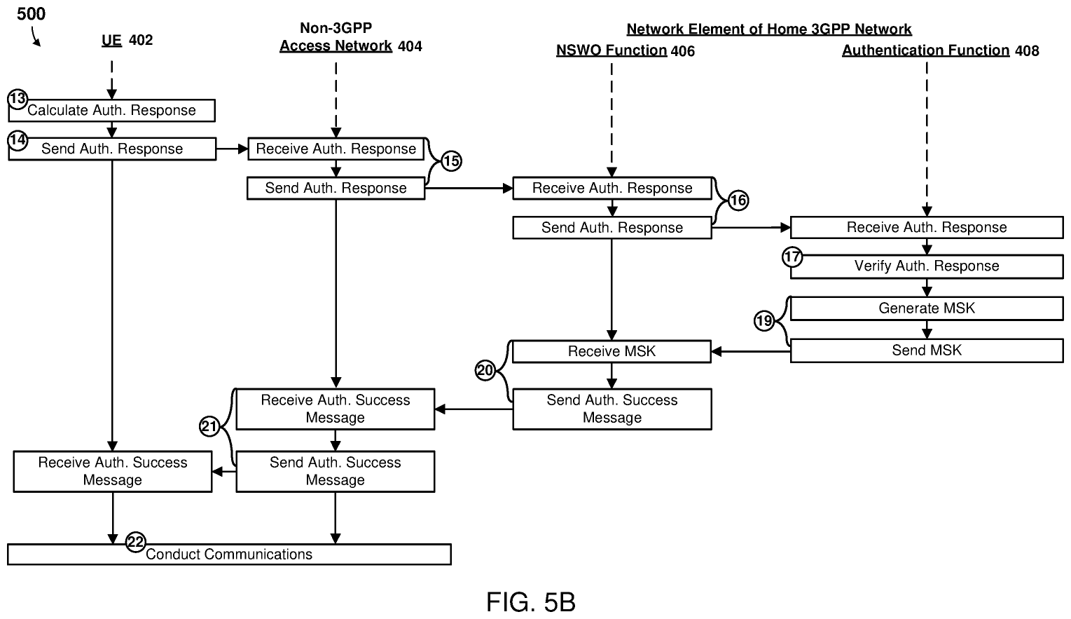

FIG. 4 is a message flow diagram illustrating wireless communications 400 that may be exchanged between various elements in a communication system including a UE, a non-3GPP network and a home 3GPP network for performing authentication of the UE to the non-3GPP network for purposes of conducting 5G NSWO in accordance with various embodiments. FIGS. 5A and 5B are method flow diagrams illustrating a method 500 that may be performed by a processor of the UE as part of authenticating the UE to the non-3GPP network for purposes of conducting 5G NSWO in accordance with various embodiments. For ease of description the communications illustrated in FIG. 4 and the operations illustrated in FIGS. 5A and 5B are labeled with matching reference numbers and FIGS. 4-5B are described together in the following description.

With reference to FIGS. 1-5B, the methods 400 and 500 may be implemented by a processor (e.g., 210, 212, 214, 216, 218, 252, 260) of a wireless device 402 (e.g., the wireless device 120a-120e, 350), a processor (e.g., 210, 212, 214, 216, 218, 252, 260) of an element of a non-3GPP access network 404 (e.g., 150), and a processor (e.g., 210, 212, 214, 216, 218, 252, 260) of an element of a core network (e.g., 140) that may provide functions such as a 5G NSWO Function 406 and an authentication function (e.g., an AUSF) 408. In various embodiments, the core network 140 may be referred to as a home 3GPP network of the UE, and may provide various functions and perform various operations, as further described herein.

In operation 0, a processor of the UE 402 may determine whether the UE is configured to perform operation for 5G NSWO. In some embodiments, the processor of the UE 402 may check a Universal Subscriber Identity Module (USIM) or a mobile equipment (ME) setting for an indication that the UE should use 5G NSWO, wherein encrypting the MSIN to generate the SUCI in the NAI format and sending the SUCI to the network element of the non-3GPP access network for authentication of the UE by the home 3GPP network for access to the non-3GPP access network is performed in response to the USIM or the ME setting indicating that the UE should use 5G NSWO. In some embodiments, such configuration indication may be on the USIM (e.g., a new USIM service or stored in an Elementary File on the USIM) or ME. Such configuration on the USIM may take precedence over any configuration on the ME in some embodiments. In some embodiments, the processor of the UE 402 may obtain by the ME function the encrypted MSIN from the USIM, and may generate (e.g., by the ME) the SUCI in the NAI format using the encrypted MSIN. In various embodiments, the processor of the UE 402 may perform the operations of block 0 before the establishment of a communication link with the non-3GPP access network 404 (as illustrated in FIG. 4), after the establishment of a communication link with the non-3GPP access network 404, or during the establishment of such communication link. In some embodiments, the UE 402 may determine whether the UE is configured to perform operation for 5G NSWO in response to receiving an identity request from the non-3GPP access network 404 (operation and communication 2).

In operation and communications 1, the UE 402 and the non-3GPP access network 404 may establish a communication link (e.g., the wireless communication link 156).

In operation and communication 2, the non-3GPP access network 404 may send to the UE 402 an identity request in response to establishing the communication link with the UE 402. As noted above, in some embodiments, the UE 402 may determine whether the UE is configured to perform operation for 5G NSWO in response to receiving an identity request from the non-3GPP access network 404.

In operation and communication 3, the UE 402 may obtain a Mobile Subscriber Identification Number (MSIN) from an International Mobile Subscriber Identity (IMSI) of the UE, encrypt the MSIN to generate a Subscription Concealed Identifier (SUCI) in a Network Access Identifier (NAI) format; and send the SUCI to the non-3GPP access network 404.

In operation and communication 4, the non-3GPP access network 404 may send an authentication request to the 5G NSWO Function 406. In some embodiments, the authentication request may include an Authentication, Authorization, and Accounting (AAA) Request via a SWa communication interface, in which a user name is set to the SUCI in the NAI format. In some embodiments, if a AAA proxy is used in the network (e.g., if the UE is roaming) the AAA proxy may forward the AAA Request to the 5G NSWO Function 406 over an SWd communication interface.

In operation 5, the 5G NSWO Function 406 may receive the authentication request including the SUCI. The 5G NSWO Function 406 may determine, based on the SUCI, that the UE should be authenticated by the authentication function 408 of the home 3GPP network. In some embodiments, the 5G NSWO Function 406 may determine that the SUCI is in the NAI format. In such embodiments, the 5G NSWO Function 406 may determine that the UE should be authenticated by the authentication function 408 of the home 3GPP network in response to determining that the SUCI is in the NAI format. In some embodiments, the 5G NSWO Function 406 may translate AAA messages into Service Based Interface (SBI) messages, e.g., for network transport.

In operation and communication 6, the 5G NSWO Function 406 may provide the authentication request including the SUCI to the authentication function 408 of the home 3GPP network for processing based on the determination that the UE should be authenticated by the authentication function. In some embodiments, the authentication function 408 processes the authentication request including the SUCI in response to determining that the SUCI is in the NAI format. In some embodiments, the 5G NSWO Function 406 may provide the authentication request including the SUCI with a “serving network name” associated with or provided for the non-3GPP access network set to an arbitrary value, such as “5G:NSWO”. In some embodiments, the 5G NSWO Function 406 may provide the authentication request to the authentication function 408 as an Nausf_UEAuthentication_Authenticate Request message in which the serving network name has been set to an arbitrary value.

In operation and communication 7, the authentication function 408 may send an authentication get request (e.g., a Nudm_UEAuthentication_Get Request) to a network authentication infrastructure element 410 (e.g., UDM/ARPF/SIDF). A UDM (Unified Data Management) network element or function may process network user data in 5G communication networks, e.g., for the authentication function 408. An ARPF (Authentication Credential Repository and Processing Function) may select an authentication method based on a subscriber identity and may compute authentication data and keying materials for the authentication function 408. An SIDF (Subscription Identifier De-concealing Function) may decrypt the SUCI to obtain a permanent UE identity (e.g., the UE SUPI or IMSI).

In operation 8, the network authentication infrastructure element 410 (may de-conceal (e.g., decrypt) the SUCI and may select an authentication protocol, such as EAP-AKA′, to use with the UE 402, as the authentication method (e.g., based on the SUPI and/or the serving network name) and generate an initial authentication vector (AV).

In operation and communication 9, the network authentication infrastructure element 410 may send to the authentication function 408 an authentication get response (e.g., a Nudm_UEAuthentication_Get Response message).

In operation and communication 10, the authentication function 408 may send an authentication challenge message (e.g. an EAP-Request/AKA′-Challenge message) to the 5G NSWO Function 406.

In operation and communication 11, the 5G NSWO Function 406 may send the authentication challenge message (e.g., the EAP-Request/AKA′-Challenge message) to the non-3GPP access network 404. In some embodiments, the 5G NSWO Function 406 may send the authentication challenge message as an AAA message.

In operation and communication 12, the non-3GPP access network 404 may send the authentication challenge message (e.g., the EAP-Request/AKA′-Challenge message) to the UE 402.

In operation 13, the UE 402 may receive the authentication challenge message (e.g., the EAP-Request/AKA′-Challenge message). The UE 402 may calculate an authentication response message (e.g., an EAP-Response) via an AKA algorithm. In some embodiments, the UE 402 may determine one or more EAP keys (e.g., a Master Session Key (MSK), an Extended MSK (EMSK), etc.) as part of operation 13, or at any time after operation 13. In some embodiments, the UE 402 may set a serving network name (SN-name) to an arbitrary value, and may derive the key(s) using the arbitrary value of the serving network name. For example, the UE 402 may set the SN-name to “5G:NSWO” in order to derive key(s) where the serving network name is needed. In some embodiments, the actual network name may be unavailable to the UE. By using an arbitrary value for the serving network name, there is no need to define or employ a procedure to enable the UE 402 and the authentication function 406 to obtain and use the actual value of the serving network or the non-3GPP access network identifier when deriving such keys.

In operation and communication 14, the UE 402 may send an authentication response (e.g., an EAP-Response, such as an EAP-Response/AKA′-Challenge message) to the non-3GPP access network 404.

In operation and communication 15, the non-3GPP access network 404 may forward the EAP-Response to the 5G NSWO Function 406 (e.g., in a AAA message).

In communication 16, the 5G NSWO Function 406 may send the EAP-Response/AKA′-Challenge message to the authentication function 408 (e.g., in an Nausf_UEAuthentication_Authenticate Request message).

In operation 17, the authentication function 408 may verify the authentication response. In response to determining that the verification of the authentication response is successful, the authentication function 408 may send an authentication failure message (e.g., EAP-Failure message) to the 5G NSWO Function 406. In response to determining that the verification of the authentication response is successful, the authentication function 408 may perform operations as further described below.

In optional operations and communications 18, the UE 402 and the authentication function 408 may exchange further EAP messages. Such EAP messages may include, for example, EAP-Request/AKA′-Notification and EAP-Response/AKA′-Notification messages via the NSWO Function. In various embodiments, the 5G NSWO Function 406 may forward such messages between the UE 402 and the authentication function 408.

In operation and communication 19, the authentication function 408 may derive (generate, calculate) a master session key (MSK) and send the MSK to the 5G NSWO Function 406. In some embodiments, the authentication function 408 may derive the MSK from an Integrity Key (e.g., IK′) and a Ciphering Key (e.g., CK′), as well as an arbitrary value for the serving network name (SN-name) where needed.

In operation and communication 20, the 5G NSWO Function 406 may send the MSK to the non-3GPP access network 404. In some embodiments, the 5G NSWO Function 406 may send an authentication success message (e.g., EAP-Success message) that may include the MSK.

In operation and communication 21, the non-3GPP access network 404 may send an authentication success message to the UE 402. In some embodiments, this completes the 5G NSWO authentication operations.

In operation and communications 22, the UE 402 and the non-3GPP access network 404 may conduct communications via established communication link.

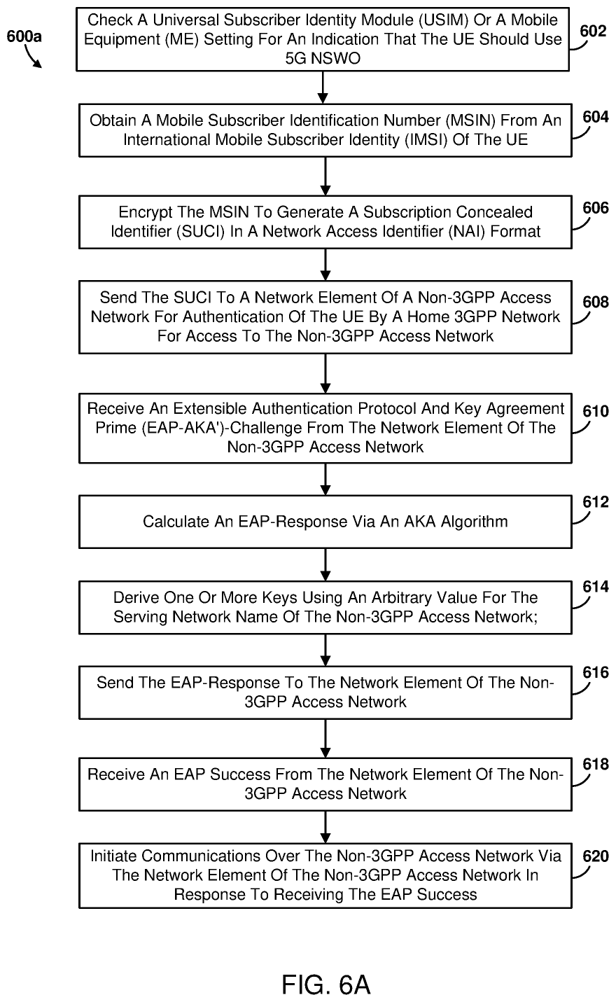

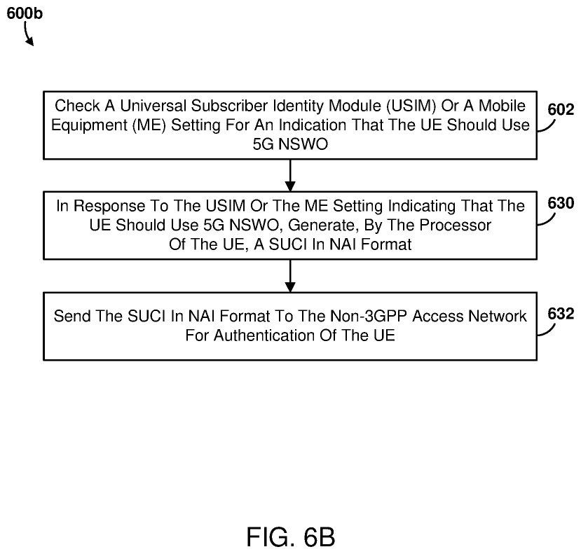

FIG. 6A is a process flow diagram illustrating a method 600a that may be performed by a processor of a UE for 5G network authentication to support 5G NSWO according to various embodiments. With reference to FIGS. 1A-6A, means for performing the operations of the method 600a may include a processor (e.g., 210, 212, 214, 216, 218, 252, 260) of a UE (e.g., the UE 120a-120e, 350, 402).

In block 602, the processor may check a Universal Subscriber Identity Module (USIM) or a mobile equipment (ME) setting for an indication that the UE should use 5G NSWO. For example, the processor may determine that the UE should use 5G NSWO procedures in response to a bit or flag value set in the USIM or in a memory register of the ME. In some embodiments, the setting to use 5G NSWO procedures may be part of the ME firmware configuration that may be preloaded in the UE as part of configuring the device for service with the home network.

In block 604, the processor may obtain a Mobile Subscriber Identification Number (MSIN) from an International Mobile Subscriber Identity (IMSI) of the UE. In some embodiments, the processor may obtain an encrypted MSIN from the USIM of the UE, and generate the SUCI in the NAI format using the encrypted MSIN.

In block 606, the processor may encrypt the MSIN to generate a Subscription Concealed Identifier (SUCI) in a Network Access Identifier (NAI) format. In some embodiments, the processor may encrypt the MSIN to generate the SUCI in the NAI format and send the SUCI to the network element of the non-3GPP access network for authentication of the UE by the home 3GPP network for access to the non-3GPP access network in response to the USIM or the ME setting indicating that the UE should use 5G NSWO.

In block 608, the processor may send the SUCI to a network element of a non-3GPP access network for authentication of the UE by a home 3GPP network for access to the non-3GPP access network. In some embodiments, sending the SUCI to the network element of the non-3GPP access network may accomplished as a response to an identity request received from the non-3GPP access network.

In block 610, the processor may receive an Extensible Authentication Protocol and Key Agreement prime (EAP-AKA′)-Challenge from the network element of the non-3GPP access network. Such an EAP-AKA′ challenge message may be consistent with conventional EAP-AKA′ protocol procedures.

In block 612, the processor may calculate an EAP-Response via an AKA algorithm. The generation of the EAP-Response via an AKA algorithm may be according to conventional EAP-AKA′ protocol procedures.

In block 614, the processor may derive or generate one or more keys using an arbitrary value for the serving network name of the non-3GPP access network. In various embodiments, the derivation/generation of one or more keys may be accomplished at any time after receiving the EAP-AKA′ challenge message.

In block 616, the processor may send the EAP-Response to the network element of the non-3GPP access network. The transmission of the EAP-AKA′ Response may be consistent with conventional EAP-AKA′ protocol procedures.

In block 618, the processor may receive an EAP Success message from the network element of the non-3GPP access network. The reception of the EAP success message indicates to the UE processor that the device has been successfully authenticated to the home network, and thus communications via the non-3GPP access network can proceed using 5G security procedures.

In block 620, the processor may initiate communications with the Internet via the network element of the non-3GPP access network in response to receiving the EAP Success.

FIG. 6B is a process flow diagram illustrating a method 600b that may be performed by a processor of a UE for 5G network authentication to support 5G NSWO according to various embodiments. With reference to FIGS. 1A-6B, means for performing the operations of the method 600b may include a processor (e.g., 210, 212, 214, 216, 218, 252, 260) of a UE (e.g., the UE 120a-120e, 350, 402).

In block 602, the processor may check a USIM or an ME setting for an indication that the UE should use 5G NSWO, as described.

In block 630, in response to the USIM or the ME setting indicating that the UE should use 5G NSWO, the processor of the UE may generate a SUCI in NAI format. In some embodiments, the processor may obtain the processor may obtain an MSIN from an IMSI of the UE. In some embodiments, the processor may obtain an encrypted MSIN from the USIM of the UE, and generate the SUCI in NAI format using the encrypted MSIN. In some embodiments, the processor may encrypt the MSIN to generate the SUCI in NAI format.

In block 632, the processor may send the SUCI in NAI format to the non-3GPP access network (e.g., to a network element of the non-3GPP access network) for authentication of the UE. In some embodiments, sending the SUCI in NAI format to the non-3GPP access network may enable a network element of a home 3GPP network of the UE to perform authentication of the UE four access to the non-3GPP access network. In some embodiments, sending the SUCI in NAI format to the network element of the non-3GPP access network may be performed as a response to receiving an identity request received from the non-3GPP access network.

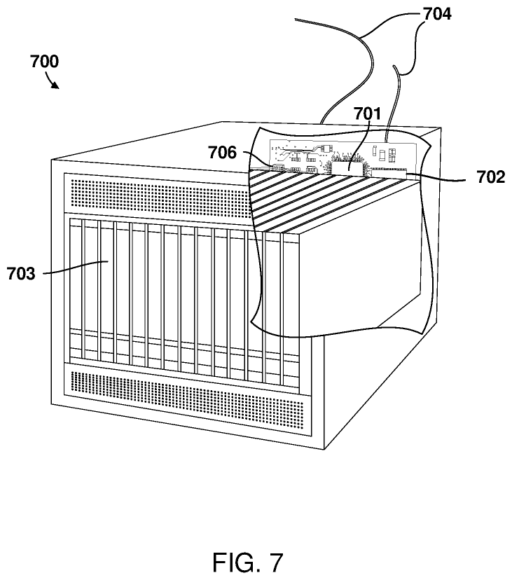

In various embodiments, operations of the methods 500-600b may be performed in a variety of network computing devices (e.g., in a network element), an example of which is illustrated in FIG. 7 that is a component block diagram of a network computing device 700 suitable for use with various embodiments. Such network computing devices may include at least the components illustrated in FIG. 7. With reference to FIGS. 1-7, a network computing device 700 may include a processor 701 coupled to volatile memory 702 and a large capacity nonvolatile memory, such as a disk drive 703. The network computing device 700 may also include a peripheral memory access device such as a floppy disc drive, compact disc (CD) or digital video disc (DVD) drive 706 coupled to the processor 701. The network computing device 700 may also include network access ports 704 (or interfaces) coupled to the processor 701 for establishing data connections with a network, such as the Internet and/or a local area network coupled to other system computers and servers. The network computing device 700 may be connected to one or more antennas for sending and receiving electromagnetic radiation that may be connected to a wireless communication link. The network computing device 700 may include additional access ports, such as USB, Firewire, Thunderbolt, and the like for coupling to peripherals, external memory, or other devices.

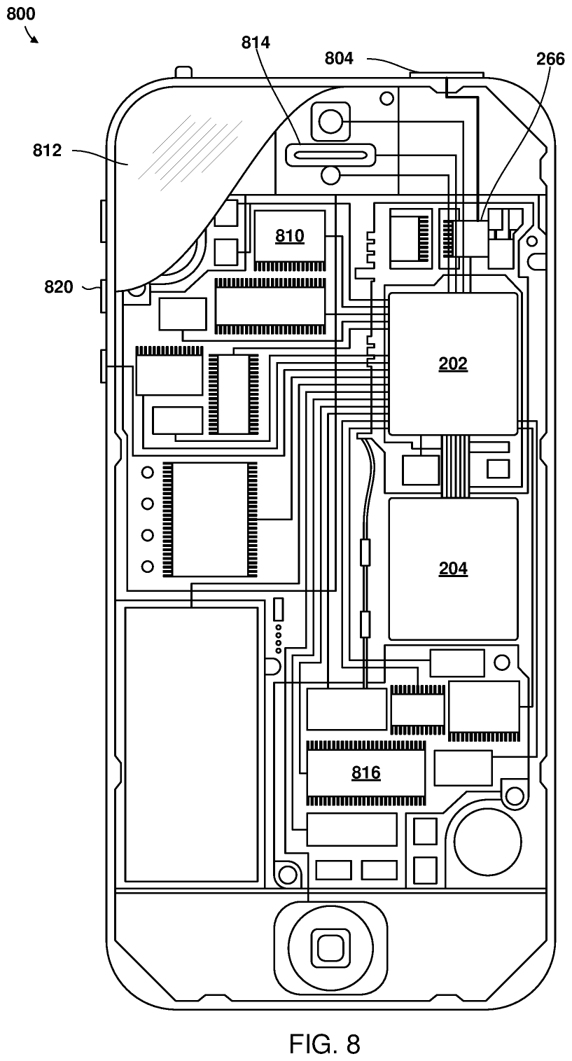

In various embodiments, operations of the methods 500-600b may be performed in a variety of wireless devices (e.g., the wireless device 120a-120e, 200, 320, 402), an example of which is illustrated in FIG. 8 that is a component block diagram of a wireless device 800 suitable for use with various embodiments. With reference to FIGS. 1-8, a wireless device 800 may include a first SOC 202 (e.g., a SOC-CPU) coupled to a second SOC 204 (e.g., a 5G capable SOC). The first and second SOCs 202, 204 may be coupled to internal memory 816, a display 812, and to a speaker 814. Additionally, the wireless device 800 may include an antenna 804 for sending and receiving electromagnetic radiation that may be connected to a wireless data link and/or cellular telephone transceiver 266 coupled to one or more processors in the first and/or second SOCs 202, 204. The wireless device 800 may also include menu selection buttons or rocker switches 820 for receiving user inputs.

The wireless device 800 also may include a sound encoding/decoding (CODEC) circuit 810, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 810 may include a digital signal processor (DSP) circuit (not shown separately).

The processors of the network computing device 800 and the wireless device 800 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SOC 204 dedicated to wireless communication functions and one processor within an SOC 202 dedicated to running other applications. Software applications may be stored in the memory 816 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the method 500 may be substituted for or combined with one or more operations of method 600a and/or method 600b.

Implementation examples are described in the following paragraphs. While some of the following implementation examples are described in terms of example systems and methods, further example implementations may include: the example operations discussed in the following paragraphs may be implemented by various devices of a system for performing authentication of a UE; the example methods discussed in the following paragraphs implemented by a UE or a network element including a processor configured with processor-executable instructions to perform operations of the methods of the following implementation examples; the example methods discussed in the following paragraphs implemented by a UE or a network element including means for performing functions of the methods of the following implementation examples; and the example methods discussed in the following paragraphs may be implemented as a non-transitory processor-readable storage medium having stored thereon processor-executable instructions configured to cause a processor of a UE or a network element to perform the operations of the methods of the following implementation examples.

Example 1. A system for performing authentication of a user equipment (UE), including a non-3GPP access network, a UE, including a processor configured with processor-executable instructions to obtain a Mobile Subscriber Identification Number (MSIN) from an International Mobile Subscriber Identity (IMSI) of the UE, encrypt the MSIN to generate a Subscription Concealed Identifier (SUCI) in a Network Access Identifier (NAI) format, and send the SUCI to the non-3GPP access network for authentication of the UE, and a network element of a home 3GPP network, including a processor configured with processor-executable instructions to receive, by a 5G Non-seamless WLAN Offload (NSWO) Function, an authentication request including the SUCI from the non-3GPP access network, determine, by the 5G NSWO Function, based on the SUCI, that the UE should be authenticated by an authentication function of the home 3GPP network, and provide the authentication request including the SUCI to the authentication function of the home 3GPP network for processing based on the determination that the UE should be authenticated by the authentication function.

Example 2. The system of example 1, in which the processor of the UE is further configured to receive an identity request from the non-3GPP access network, and determine based on an indicator stored in the UE whether the UE is configured to perform 5G NSWO in response to the identity request.

Example 3. The system of either of examples 1 and 2, in which the processor of the network element of the home 3GPP network is further configured to determine, by the 5G NSWO Function, that the SUCI is in the NAI format.

Example 4. The system of example 3, in which the authentication function processes the authentication request including the SUCI in response to determining that the SUCI is in the NAI format.

Example 5. The system of any of examples 1-3, in which the authentication function includes an Authentication Server Function (AUSF).

Example 6. The system of any of examples 1-5, in which the non-3GPP access network is further configured to establish a communication link with the UE, and send to the UE an identity request in response to establishing the communication link with the UE.

Example 7. The system of any of examples 1-6, in which the processor of the network element of the home 3GPP network is further configured to receive, by the 5G NSWO Function from the authentication function, an authentication response based on the processing of the authentication request including the SUCI, and send, by the 5G NSWO Function, an authentication challenge to the non-3GPP access network in response to receiving the authentication response from the authentication function.

Example 8. The system of any of examples 1-7, in which the processor of the UE is further configured to receive the authentication challenge from the non-3GPP access network, generate an authentication response in response to the authentication challenge, and send to the non-3GPP access network the authentication response.

Example 9. The system of example 8, in which the processor of the UE is further configured to generate a key using an arbitrary value for a serving network name of the non-3GPP access network.

Example 10. The system of example 8, in which the processor of the network element of the home 3GPP network is further configured to receive, by the 5G NSWO Function from the UE via the non-3GPP access network, the authentication response in response to the authentication challenge, provide the authentication response to the authentication function of the home 3GPP network, and receive, by the 5G NSWO Function from the authentication function of the home 3gpp network, a Master Session Key (MSK) responsive to the authentication response.

Example 11. The system of example 10, in which the processor of the network element of the home 3GPP network is further configured to send the MSK to the non-3GPP access network to authenticate the UE for access to the non-3GPP access network.

Example 12. The system of example 10, in which the MSK is derived using an arbitrary value for a serving network name of the non-3GPP access network.

Example 13. A method for performing authentication of a user equipment (UE) for 5G network authentication to support 5G Non-seamless WLAN Offload (5G NSWO) on a non-3GPP access network, including obtaining, by a processor of a UE, a Mobile Subscriber Identification Number (MSIN) from an International Mobile Subscriber Identity (IMSI) of the UE, encrypting, by the processor of the UE, the MSIN to generate a Subscription Concealed Identifier (SUCI) in a Network Access Identifier (NAI) format, sending, by the processor of the UE, the SUCI to the non-3GPP access network for authentication of the UE, receiving, from the non-3GPP access network by a 5G NSWO Function of a network element of a home 3GPP network, an authentication request including the SUCI, determining, by the 5G NSWO Function, based on the SUCI, that the UE should be authenticated by an authentication function of the home 3GPP network, providing the authentication request including the SUCI to the authentication function of the home 3GPP network for processing based on the determination that the UE should be authenticated by the authentication function, and completing authentication of the UE according to the Extensible Authentication Protocol (EAP) protocol.

Example 14. The method of example 13, in which determining, by the 5G NSWO Function, based on the SUCI, that the UE should be authenticated by an authentication function of the home 3GPP network includes determining, by the 5G NSWO Function, that the SUCI is in the NAI format.

Example 15. The method of example 14, further including processing, by the authentication function, the authentication request including the SUCI in response to determining that the SUCI is in the NAI format.

Example 16. The method of example 13, in which the authentication function includes an Authentication Server Function (AUSF).

Example 17. A method performed by a processor of a user equipment (UE) for 5G network authentication to support 5G Non-seamless WLAN Offload (NSWO), including obtaining a Mobile Subscriber Identification Number (MSIN) from an International Mobile Subscriber Identity (IMSI) of the UE, encrypting the MSIN to generate a Subscription Concealed Identifier (SUCI) in a Network Access Identifier (NAI) format, and sending the SUCI to a network element of a non-3GPP access network for authentication of the UE by a home 3GPP network for access to a non-3GPP access network.

Example 18. The method of example 17, further including checking a Universal Subscriber Identity Module (USIM) or a mobile equipment (ME) setting for an indication that the UE should use 5G NSWO, in which encrypting the MSIN to generate the SUCI in the NAI format and sending the SUCI to the network element of the non-3GPP access network for authentication of the UE by the home 3GPP network for access to the non-3GPP access network is performed in response to the USIM or the ME setting indicating that the UE should use 5G NSWO.

Example 19. The method of either of examples 17 or 18, in which obtaining the MSIN from the IMSI of the UE includes obtaining by an ME function of the UE an encrypted MSIN from a USIM of the UE, and generating by the ME the SUCI in the NAI format using the encrypted MSIN.

Example 20. The method of any of examples 17-19, further including receiving an Extensible Authentication Protocol and Key Agreement prime (EAP-AKA′)-Challenge from the network element of the non-3GPP access network, calculating an EAP-Response via an AKA algorithm, deriving one or more keys using an arbitrary value for the serving network name of the non-3GPP access network, sending the EAP-Response to the network element of the non-3GPP access network, receiving an EAP Success from the network element of the non-3GPP access network, and initiating communications over the non-3GPP access network via the network element of the non-3GPP access network in response to receiving the EAP Success.

Example 21. A method for 5G network authentication to support 5G Non-seamless WLAN Offload (NSWO) on a non-3GPP access network, including checking, by a processor of a UE, a Universal Subscriber Identity Module (USIM) or a mobile equipment (ME) setting for an indication that the UE should use 5G NSWO, in response to the USIM or the ME setting indicating that the UE should use 5G NSWO, generating, by the processor of the UE, a Subscription Concealed Identifier (SUCI) in Network Access Identifier (NAI) format, and sending, by the processor of the UE, the SUCI in NAI format to the non-3GPP access network for authentication of the UE.

Example 22. The method of example 21, in which sending, by the processor of the UE, the SUCI in NAI format to the non-3GPP access network for authentication of the UE includes receiving, by the UE, an identity request from the non-3GPP access network, and sending, by the processor of the UE, the SUCI in NAI format to the non-3GPP access network for authentication of the UE in response to the identity request from the non-3GPP access network.

Example 23. The method of either of examples 21 or 22, in which generating, by the processor of the UE, the SUCI in NAI format includes encrypting, by the processor of the UE, a Mobile Subscriber Identification Number (MSIN) obtained from an International Mobile Subscriber Identity (IMSI) of the UE to generate the SUCI in NAI format.

Example 24. The method of either of examples 21 or 22, in which generating, by the processor of the UE, the SUCI in NAI format includes obtaining by an ME function of the UE an encrypted MSIN from a USIM of the UE, and generating by the ME function the SUCI in NAI format using the encrypted MSIN.

Example 25. The method of any of examples 21-24, in which sending, by the processor of the UE, the SUCI in NAI format to the non-3GPP access network for authentication of the UE includes sending, by the processor of the UE, the SUCI in NAI format to the non-3GPP access network for authentication of the UE in response to an identity request received by the UE from the non-3GPP access network.

Example 26. The method of any of examples 21-25, in which generating, by the processor of the UE, the SUCI in NAI format includes encrypting a username portion of an NAI and incorporating an encrypted username of the NAI to form the SUCI in NAI format.

Example 27. The method of any of examples 21-26, in which the SUCI in NAI format includes an indication of whether the SUCI is derived from an IMSI of the UE or an NAI.

Example 28. The method of any of examples 21-27, in which generating, by the processor of the UE, the SUCI in NAI format includes converting digits of an IMSI of the UE into a domain name.

Example 29. The method of any of examples 21-28, further including receiving an Extensible Authentication Protocol and Key Agreement prime (EAP-AKA′)-Challenge from the network element of the non-3GPP access network, deriving one or more keys using an arbitrary value for a serving network name of the non-3GPP access network, sending an EAP-Response to the network element of the non-3GPP access network, and initiating communications over the non-3GPP access network via the network element of the non-3GPP access network using the one or more derived keys.

Example 30. The method of example 29, in which initiating communications over the non-3GPP access network via the network element of the non-3GPP access network includes receiving an EAP Success from the network element of the non-3GPP access network, and initiating communications over the non-3GPP access network via the network element of the non-3GPP access network in response to receiving the EAP Success.

Example 31. A method for 5G network authentication to support 5G NSWO on a non-3GPP access network, including: checking, by a processor of a UE, a USIM or a ME setting for an indication that the UE should use 5G NSWO; and in response to the USIM or the ME setting indicating that the UE should use 5G NSWO: generating, by the processor of the UE, a SUCI in NAI format; and sending, by the processor of the UE, the SUCI in NAI format to the non-3GPP access network for authentication of the UE.

Example 32. The method of example 31, in which sending, by the processor of the UE, the SUCI in NAI format to the non-3GPP access network for authentication of the UE is performed in response to receiving, by the UE, an identity request from the non-3GPP access network.

Example 33. The method of any of examples 31-32, in which generating, by the processor of the UE, the SUCI in NAI format includes encrypting, by the processor of the UE, a Mobile Subscriber Identification Number (MSIN) obtained from an International Mobile Subscriber Identity (IMSI) of the UE and including the encrypted MSIN in the SUCI.

Example 34. The method of any of examples 31-33, in which generating, by the processor of the UE, the SUCI in NAI format includes: obtaining by an ME function of the UE an encrypted MSIN from a USIM of the UE; and using the encrypted MSIN to generate the SUCI in NAI format by the ME function.

Example 35. The method of any of examples 31-34, in which generating, by the processor of the UE, the SUCI in NAI format includes encrypting a username portion of an NAI and incorporating the encrypted username portion in the NAI in the SUCI.

Example 36. The method of any of examples 31-35, in which the SUCI in NAI format includes an indication of whether the SUCI is derived from an IMSI of the UE or an NAI.

Example 37. The method of any of examples 31-36, in which generating, by the processor of the UE, the SUCI in NAI format includes converting digits of an IMSI of the UE into a domain name.

Example 38. The method of any of examples 31-37, further including: receiving an Extensible Authentication Protocol and Key Agreement prime (EAP-AKA′)-Challenge from a network element of the non-3GPP access network; deriving one or more keys using an arbitrary value for a serving network name of the non-3GPP access network; sending an EAP-Response to the network element of the non-3GPP access network; and initiating communications over the non-3GPP access network via the network element of the non-3GPP access network using the one or more derived keys.

Example 39. The method of example 38, in which initiating communications over the non-3GPP access network via the network element of the non-3GPP access network includes: receiving an EAP Success from the network element of the non-3GPP access network; and initiating communications over the non-3GPP access network via the network element of the non-3GPP access network in response to receiving the EAP Success.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A user equipment (UE), comprising:
a processor configured to:
check a Universal Subscriber Identity Module (USIM) or a mobile equipment (ME) setting for an indication that the UE should use 5G Non-seamless WLAN Offload (NSWO); and
in response to the USIM or the ME setting indicating that the UE should use 5G NSWO:
generate a Subscription Concealed Identifier (SUCI) in Network Access Identifier (NAI) format; and
send the SUCI in NAI format to a non-3GPP access network for authentication of the UE.

2. The UE of claim 1, wherein:
the processor is further configured to receive an identity request from the non-3GPP access network; and
sending the SUCI in NAI format to the non-3GPP access network for authentication of the UE is performed in response to the identity request from the non-3GPP access network.

3. The UE of claim 1, wherein to generate the SUCI in NAI format the processor is further configured to encrypt a Mobile Subscriber Identification Number (MSIN) obtained from an International Mobile Subscriber Identity (IMSI) of the UE and include the encrypted MSIN in the SUCI.

4. The UE of claim 1, wherein:
the processor is further configured to obtain by an ME function of the UE an encrypted MSIN from a USIM of the UE; and
to generate the SUCI in NAI format the ME function uses the encrypted MSIN.

5. The UE of claim 1, wherein to generate the SUCI in NAI format, the processor is further configured to encrypt a username portion of an NAI and incorporate the encrypted username portion in the SUCI.

6. The UE of claim 1, wherein the SUCI in NAI format includes an indication of whether the SUCI is derived from an IMSI of the UE or an NAI.

7. The UE of claim 1, wherein the processor is further configured to convert digits of an IMSI of the UE into a domain name.

8. The UE of claim 1, wherein the processor is further configured to:
receive an Extensible Authentication Protocol and Key Agreement prime (EAP-AKA′)-Challenge from a network element of the non-3GPP access network;
derive one or more keys using an arbitrary value for a serving network name of the non-3GPP access network;
send an EAP-Response to the network element of the non-3GPP access network; and
initiate communications over the non-3GPP access network via the network element of the non-3GPP access network using the one or more derived keys.

9. The UE of claim 8, wherein the processor is further configured to:
receive an EAP Success from the network element of the non-3GPP access network; and
initiate communications over the non-3GPP access network via the network element of the non-3GPP access network in response to receiving the EAP Success.

10. A method for 5G network authentication to support 5G Non-seamless WLAN Offload (NSWO) on a non-3GPP access network, comprising:
checking, by a processor of a user equipment (UE), a Universal Subscriber Identity Module (USIM) or a mobile equipment (ME) setting for an indication that the UE should use 5G NSWO; and
in response to the USIM or the ME setting indicating that the UE should use 5G NSWO:
generating, by the processor of the UE, a Subscription Concealed Identifier (SUCI) in Network Access Identifier (NAI) format; and
sending, by the processor of the UE, the SUCI in NAI format to the non-3GPP access network for authentication of the UE.

11. The method of claim 10, wherein sending, by the processor of the UE, the SUCI in NAI format to the non-3GPP access network for authentication of the UE is performed in response to receiving, by the UE, an identity request from the non-3GPP access network.

12. The method of claim 10, wherein generating, by the processor of the UE, the SUCI in NAI format comprises encrypting, by the processor of the UE, a Mobile Subscriber Identification Number (MSIN) obtained from an International Mobile Subscriber Identity (IMSI) of the UE and including the encrypted MSIN in the SUCI.

13. The method of claim 10, wherein generating, by the processor of the UE, the SUCI in NAI format comprises:
obtaining by an ME function of the UE an encrypted MSIN from a USIM of the UE; and
using the encrypted MSIN to generate the SUCI in NAI format by the ME function.

14. The method of claim 10, wherein generating, by the processor of the UE, the SUCI in NAI format comprises encrypting a username portion of an NAI and incorporating the encrypted username portion in the NAI in the SUCI.

15. The method of claim 10, wherein the SUCI in NAI format includes an indication of whether the SUCI is derived from an IMSI of the UE or an NAI.

16. The method of claim 10, wherein generating, by the processor of the UE, the SUCI in NAI format comprises converting digits of an IMSI of the UE into a domain name.

17. The method of claim 10, further comprising:
receiving an Extensible Authentication Protocol and Key Agreement prime (EAP-AKA′)-Challenge from a network element of the non-3GPP access network;
deriving one or more keys using an arbitrary value for a serving network name of the non-3GPP access network;
sending an EAP-Response to the network element of the non-3GPP access network; and
initiating communications over the non-3GPP access network via the network element of the non-3GPP access network using the one or more derived keys.

18. The method of claim 17, wherein initiating communications over the non-3GPP access network via the network element of the non-3GPP access network comprises:
receiving an EAP Success from the network element of the non-3GPP access network; and
initiating communications over the non-3GPP access network via the network element of the non-3GPP access network in response to receiving the EAP Success.

19. A non-transitory processor-readable medium having stored thereon processor-executable instructions configured to cause a processing device in a user equipment (UE), to perform operations comprising:
checking a Universal Subscriber Identity Module (USIM) or a mobile equipment (ME) setting for an indication that the UE should use 5G Non-seamless WLAN Offload (NSWO);
in response to the USIM or the ME setting indicating that the UE should use 5G NSWO, generating a Subscription Concealed Identifier (SUCI) in Network Access Identifier (NAI) format; and
sending the SUCI in NAI format to a non-3GPP access network for authentication of the UE.
